(19) United States
(12) Patent Application Publication
(10) Pub. No.: US 2026/0180697 A1
(43) Pub. Date: Jun. 25, 2026

(54) EMITTER SELECTION

(71) Applicant: Aurelian Industries, LLC, Menlo Park, CA (US)

(72) Inventors: Reese FRERICHS, Boston, MA (US); Alexander MEZHIROV, Lexington, MA (US); Andrzej WALCZAK, Watertown, MA (US)

(21) Appl. No.: 19/426,040

(22) Filed: Dec. 18, 2025

Related U.S. Application Data
(60) Provisional application No. 63/737,568, filed on Dec. 20, 2024.
(60) Provisional application No. 63/746,895, filed on Jan. 17, 2025.

(51) Int. Cl. H04B 17/318; G01S 13/28; G01S 13/89

(52) U.S. Cl. CPC H04B 17/318; G01S 13/282; G01S 13/89

(57) ABSTRACT

A system includes at least one processor and a memory comprising computer program code. The memory and the computer program code are configured to, with the at least one processor, cause the at least one processor to: receive, by a platform, signals from potential emitters, wherein each of the signals has a measurable signal characteristic; identify signal characteristics associated with the potential emitters; assign a priority level to each of the potential emitters based on one or more priority criteria of the potential emitters; select one of the potential emitters using the assigned priority levels and the identified signal characteristics of the potential emitters; and generate a command that initiates an action with respect to the selected potential emitter.

### CROSS-REFERENCE TO RELATED APPLICATIONS

This non-provisional utility application claims priority to provisional patent application No. 63/737,568, entitled “EMITTER SELECTION” and filed on Dec. 20, 2024, provisional patent application No. 63/893,387, entitled “RADIO FREQUENCY DETECTION” and filed on Oct. 3, 2025, and provisional patent application No. 63/746,895, entitled RADIO FREQUENCY LANDSCAPE MAP and filed on Jan. 17, 2025, each of which is incorporated herein in its entirety by reference.

### BACKGROUND

It is technically difficult to accurately identify and prioritize signals emitted from multiple potential sources.

### SUMMARY

In one aspect, a system includes at least one processor and a memory comprising computer program code. The memory and the computer program code are configured to, with the at least one processor, cause the at least one processor to: receive, by a platform, signals from potential emitters, wherein each of the signals has a measurable signal characteristic; identify signal characteristics associated with the potential emitters; assign a priority level to each of the potential emitters based on one or more priority criteria of the potential emitters; select one of the potential emitters using the assigned priority levels and the identified signal characteristics of the potential emitters; and generate a command that initiates an action with respect to the selected potential emitter.

In another aspect, a computer-implemented method includes: receiving, by a platform, signals from potential emitters, wherein each of the signals has a measurable signal characteristic; identifying signal characteristics associated with the potential emitters; assigning a priority level to each of the potential emitters based on one or more priority criteria of the potential emitters; selecting one of the potential emitters using the assigned priority levels and the identified signal characteristics of the potential emitters; and generating a command that initiates an action with respect to the selected potential emitter.

In another aspect, a computer-readable memory device stores instructions that, when executed by at least one processor, cause the at least one processor to: receive, by a platform, signals from potential emitters, wherein each of the signals has a measurable signal characteristic; identify signal characteristics associated with the potential emitters; assign a priority levels to each of the potential emitters based on one or more priority criteria of the potential emitters; select one of the potential emitters using the assigned priority levels and the identified signal characteristics of the potential emitters; and generate a command that initiates an action with respect to the selected potential emitter.

### BRIEF DESCRIPTION OF THE DRAWINGS

FIG. 1 is a schematic diagram illustrating an emitter selection system according to an implementation.

FIG. 2 is a flowchart illustrating a method of operation of the emitter selection system of FIG. 1 according to an implementation.

FIG. 3 is a flowchart illustrating another method of operation of the emitter selection system of FIG. 1 according to an implementation.

FIG. 4 is a flowchart illustrating another method of operation of the emitter selection system of FIG. 1 according to an implementation.

FIG. 5 is a flowchart illustrating another method of operation of the emitter selection system of FIG. 1 according to an implementation.

FIG. 6 is a schematic diagram illustrating the system of FIG. 1 being deployed onboard a mobile platform according to an implementation.

FIG. 7 is a schematic diagram illustrating an exemplary operating environment of the disclosure according to an implementation.

### DETAILED DESCRIPTION

It is technically difficult to accurately identify and prioritize signals emitted from multiple potential sources. At least some systems rely solely on signal strength (e.g., detection of the strongest signal) for emitter selection. However, in environments where signals display complex behaviors, for example, erratic, intermittent, unstable, signal modifying, or pulsing emissions, relying on signal strength can lead to suboptimal emitter selection. Existing systems may be unable to discriminate between signals of similar strength and/or be unable to adapt to evolving signal landscapes, thereby limiting their ability to identify and locate emitters accurately. A reduced ability to adaptively respond to changes in signal characteristics can result in reduced accuracy in emitter finding.

In contrast, aspects of the disclosure integrate priority levels in combination with signal strength to enhance emitter selection, enabling more accurate differentiation and prioritization of signals. Aspects of the disclosure are operable in any environment where emitters are present (e.g., environments where emitter selection and/or signal differentiation is desired, etc.). This includes, but is not limited to, environments with complex signal behavior, where multiple signal sources are present, and/or the like. For example, the methods and systems disclosed herein are operable in a range of applications including, but not limited to, air traffic control, security, surveillance, autonomous navigation, telecommunications, emergency response, disaster management, defense, military, and/or the like. For example, the ability of aspects of the disclosure to operate in diverse environments, including at ground-based installations and onboard mobile platforms, enables more flexible deployment.

An example application includes air traffic control where prioritization among various aircraft signals (e.g., wherein the emitter is from an aircraft) is desired for maintaining safe distances and efficient routing. For example, the integration of the priority assessment and signal feature discrimination features described herein enhance the ability of a system to accurately identify and/or track aircraft signals based on transponder emissions from those aircraft. The integration of the priority assessment and signal feature discrimination features described herein ensures more efficient management of air traffic by differentiating among signals of similar strength. Further, by analyzing historical data, aspects of the disclosure can optimize aircraft routing thereby reducing congestion.

Emergency response operations are another example application. For example, when deployed in a disaster response scenario, aspects of the disclosure prioritize signals emitted by emergency emitters (e.g., beacons, signals from distressed individuals) to enable responders to maintain focus on signals, from critical emitters, that may be intermittent due to challenging environmental conditions to ensure aid is properly directed. Some examples integrate data from other sensors to enhance search and rescue missions. For example, the combination of thermal imaging and visual inspection through infrared and/or first person view cameras enables the identification of heat signatures from individuals or groups in distress, even in obscured or remote areas. This aids in the precise localization of emitters, expediting rescue efforts in challenging terrain or adverse weather.

In another example, the modular and configurable nature of some implementations of the system enables applications in the autonomous navigation of unmanned aerial aircraft (UAVs) (e.g., drones), for example for tasks such as infrastructure inspection, wildlife monitoring, agricultural surveys, and/or the like. By more accurately selecting and prioritizing emitters based on signal strength and predefined criteria, UAVs can more effectively monitor specific elements within a complex signal environment.

In a telecommunications industry example, aspects of the disclosure optimize signal quality management by prioritizing wireless communication signals in crowded networks. The ability to distinguish between signals based on frequency and/or modulation patterns improves signal clarity and reduces interference in densely populated areas or at large events.

In the context of security and surveillance, aspects of the disclosure can be deployed to monitor public events, such as concerts, sports games, political gatherings, protests, and/or the like, for example to detect unauthorized activity (e.g., mobile platform activity, etc.) that may pose a security threat and/or violate airspace regulations. By detecting, localizing, and prioritizing signals, aspects of the disclosure improve event security and facilitate enforcing compliance with airspace regulations. For example, the ability to pinpoint the location of emitters (e.g., a mobile platform, a stationary platform, a radio frequency (RF) emitter, etc.) enables security personnel to more quickly respond to potential threats, ensuring the safety of attendees and maintaining the integrity of the event.

In another example of a security and surveillance application, aspects of the disclosure can be utilized (e.g., in urban environments, in rural environments, etc.) to monitor infrastructure (such as airports, government buildings, bridges, roads, water supplies, power plants, and/or the like) for potential threats (e.g., a mobile platform, another emitter, etc.). For example, by identifying, characterizing, and prioritizing signals, aspects of the disclosure provide an additional layer of security against unauthorized surveillance, interference, attack, and/or the like. In some examples, aspects of the disclosure are capable of operating in diverse environments, including at ground-based installations, for example enabling more flexible deployment in urban settings.

In defense and/or military applications, aspects of the disclosure are utilized to identify and track emitters (e.g., communication equipment, electronic jamming equipment, mobile platforms, stationary platforms, etc.), for example providing improved situational awareness, improved threat assessment, an improved ability to respond to potential threats, and/or the like. In battlefield scenarios, the disclosed systems capability of operating onboard mobile platforms enables real-time monitoring and tracking of signals, for example supporting tactical decision-making and improving operational effectiveness.

Aspects of the disclosure operate in an unconventional manner at least by providing a system that includes at least one processor and a memory comprising computer program code. The memory and the computer program code are configured to, with the at least one processor, cause the at least one processor to: receive, by a platform, signals from potential emitters, wherein each of the signals has a measurable signal characteristic; identify signal characteristics associated with the potential emitters; assign a priority level to each of the potential emitters based on one or more priority criteria of the potential emitters; select one of the potential emitters using the assigned priority levels and the identified signal characteristics of the potential emitters; and generate a command that initiates an action with respect to the selected potential emitter.

Aspects of the disclosure operate in an unconventional manner at least by providing a computer-implemented method that includes: receiving, by a platform, signals from potential emitters, wherein each of the signals has a measurable signal characteristic; identifying signal characteristics associated with the potential emitters; assigning a priority level to each of the potential emitters based on one or more priority criteria of the potential emitters; selecting one of the potential emitters using the assigned priority levels and the identified signal characteristics of the potential emitters; and generating a command that initiates an action with respect to the selected potential emitter.

Aspects of the disclosure operate in an unconventional manner at least by providing a computer-readable memory device storing instructions that, when executed by at least one processor, cause the at least one processor to: receive, by a platform, signals from potential emitters, wherein each of the signals has a measurable signal characteristic; identify signal characteristics associated with the potential emitters; assign a priority levels to each of the potential emitters based on one or more priority criteria of the potential emitters; select one of the potential emitters using the assigned priority levels and the identified signal characteristics of the potential emitters; and generate a command that initiates an action with respect to the selected potential emitter

Example technical solutions to the technical problems described herein are provided by aspects of the disclosure using an integrated system, executable via software, that enhances emitter selection through several components (e.g., a priority assessment module, a historical analysis module, signal feature discrimination, multi-sensor integration, etc.). The priority assessment module preforms the technical solution of assigning priority levels to detected signals based on predefined criteria, for example enabling the technical effect of differentiation among signals that are close in strength. The priority assessment module enables the technical solution of prioritizing of emitters beyond mere signal strength (e.g., addressing scenarios where emitters may use deceptive signal tactics, etc.). The priority assessment module enhances emitter selection by incorporating priority levels alongside signal strength and/or other signal characteristics, which enables the technical effect of more accurate differentiation and prioritization of signals, for example particularly in scenarios involving emitters with intermittent, pulsing, signal modifying, and/or other complex and/or multifaceted signal characteristics.

The historical analysis module performs the technical solution of using historical signal analysis to inform emitter selection decisions, for example enabling the technical solution of dynamic adjustment of emitter selection by using historical data to retain and/or switch emitters, which provides the technical effect of being more effective for dealing with signals exhibiting intermittent, pulsing, signal modifying, and/or other complex signal characteristics. For example, utilizing historical signal data, the historical analysis module enables the technical solution of strategic switching among emitters, which provides the technical effect of enabling the retention of signals that may temporarily disappear, enhancing adaptability to tactical emitter behaviors.

Some aspects of the disclosure provide and employ the technical solution of signal fingerprinting capabilities including signal feature discrimination techniques (e.g., via Fast Fourier Transforms (FFTs), spectral analysis, emitter prioritization algorithms, machine learning, etc.) to analyze frequency characteristics. In this manner, the technical solution of distinct signal fingerprints can be generated which enables the technical effect of enhanced classification and/or more precise emitter selection. For example, by employing signal feature discrimination techniques, the system accomplishes discrimination of signals based on frequency and/or modulation patterns, creating distinct fingerprints and/or signatures for more precise signal classification.

Aspects of the disclosure include the technical solution of multi-sensor integration (e.g., the incorporation of multi-sensor inputs), for example for emitter localization, informing emitter selection decisions, and/or emitter engagement. For example, aspects of the disclosure integrate infrared (IR) cameras, FPV cameras, visual (visible spectrum) cameras, close-range radar, medium-range radar, long-range radar, and/or the like. The multi-sensor approach of aspects of the disclosure provides the technical effect of refining emitter localization and/or engagement, for example providing additional data (e.g., a heat signature, etc.) to validate emitter presence, optimize engagement strategies, aid in the approach and/or reaffirmation of emitter positions, and/or the like.

The technical solution of close-range radar deployment for emitter engagement is provided in some examples. The use of short-range radar provides the technical effect of enhancing accuracy in emitter engagement phases, for example by providing more precise targeting information.

Aspects of the disclosure provide a configurable pre-launch emitter selection system which can be tailored before deployment to align with specific objectives and/or threat environments, offering adaptability in varying contexts.

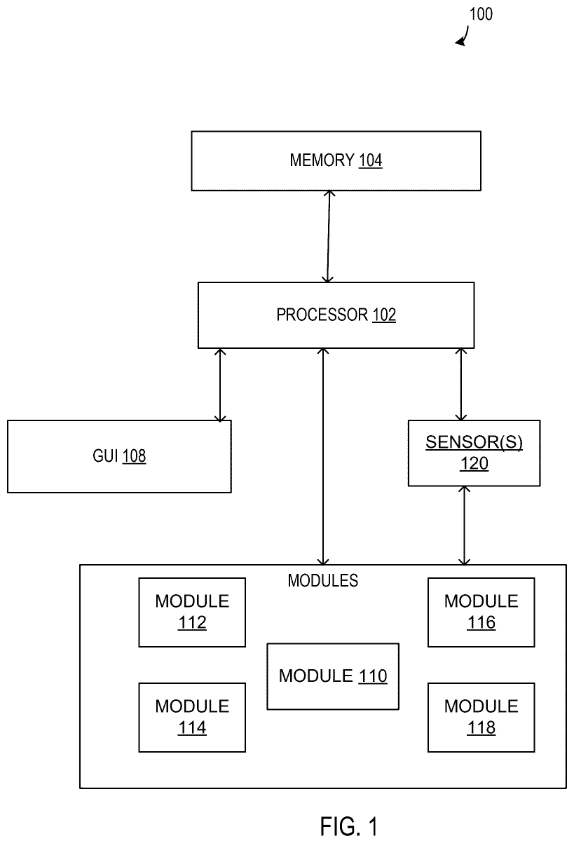

Referring to the figures, FIG. 1 is a block diagram illustrating an emitter selection system 100. In some examples, the system 100 includes a processor 102 and a memory 104 configured to store computer program code. The memory 104 and the computer program code are configured to, with the processor 102, cause the processor 102 to perform various operations, functions, and/or the like of the system 100 (e.g., the various operations, functions, and/or the like described and/or illustrated herein, etc.). In some examples, there are four different processors, for example, one for each of flight control, signal analysis, communications, and mission analysis. For example, the processor 102 may function as a central processing entity, managing operations and coordinating data flow between components. The memory 104 is connected to the processor 102 and stores instructions and data necessary for the execution of emitter selection processes (e.g., functions and algorithms for the identification and prioritization of emitters based on signal characteristics and/or other parameters, etc.).

In some examples, one or more operations, functions, results, conclusions, calculations, determinations, detections, and/or the like of the system 100 (e.g., the various operations, functions, results, conclusions, calculations, determinations, detections, and/or the like described and/or illustrated herein, etc.) can be provided for display via a graphical user interface (GUI) (e.g., as described and/or illustrated herein; a GUI 108 of the system 100; a GUI of another system, computing device, electronic device, server, and/or the like; etc.) and/or used for other purposes. The GUI 108 is interfaced with the processor 102, enabling user interaction and visualization of data processed by the system 100, for example allowing for configuration changes and/or monitoring of emitter selection procedures.

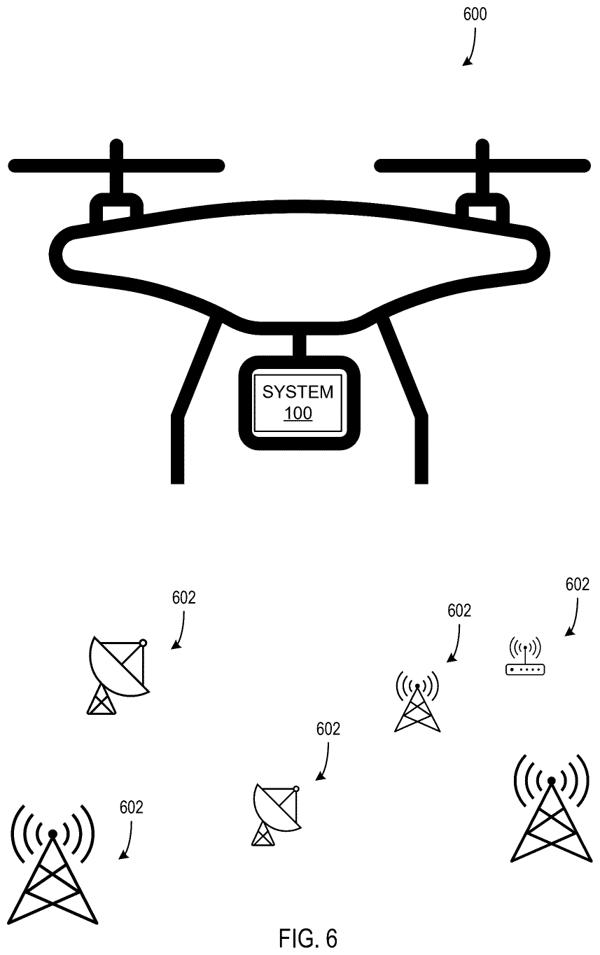

In some examples, the system 100 is configured for use onboard a platform, such as, but not limited to, a mobile platform (e.g., the mobile platform 600 shown in FIG. 6, etc.), a stationary platform, and/or the like. Examples of mobile platforms include, but are not limited to, uncrewed vehicles, aircraft (e.g., rotorcraft, fixed wing aircraft, gliders, lighter-than-air craft, balloons, high-altitude balloons, uncrewed aerial vehicles (UAVs), etc.), land vehicles, uncrewed ground vehicles (UGVs), marine vehicles, surface vehicles, submersibles, uncrewed marine vehicles (UMVs), uncrewed surface and/or submersible vehicles (USVs), space-based platforms, suborbital vehicles, vehicles that operate in orbit, platforms carried by an individual (e.g., a backpack and/or other carrying pack, etc.), animals (e.g., a flying animal such as a bird and/or insect, a land animal, a marine animal, etc.), missiles, rockets, uncrewed mobile platforms, autonomous mobile platforms, and/or the like. As used herein, the system 100 may be used onboard a mobile platform while the mobile platform is moving and/or while the mobile platform is stationary. Examples of stationary platforms include, but are not limited to, stations, arrays, central controls, towers, cellular towers, fixed positions, fixed structures, stationary vehicles, uncrewed stationary platforms, autonomous stationary platforms, buildings, emplacements, installations, ground-based installations, forts, prisons, government locations, government buildings, stadiums, parks, public spaces, infrastructure, dams, public venues, private venues, concert venues, sporting venues, and/or the like. The system 100 may be used, for example, while the platform is within a range (e.g., signal receiving range, visual range, radar range, a distance range, etc.) of one or more potential emitters. In some examples, the systems and methods disclosed herein are used with one or more uncrewed, autonomous platforms.

The emitters described and/or illustrated herein (e.g., the emitters 602 shown in FIG. 6, etc.) may include any type of emitter, such as, but not limited to, a radio frequency (RF) emitter, a microwave emitter, an infrared (IR) emitter, a transmitter, an RF transmitter, a microwave transmitter, an IR transmitter, a television tower, a radio tower, a broadcasting station, a beacon, a cellular tower, a mobile platform, a stationary platform, a terrestrial emitter, a mobile emitter, a stationary emitter, an airborne emitter, an uncrewed emitter, an autonomous emitter, a jamming emitter, and/or the like. In some examples, the emitter includes an electronic jamming emitter (e.g., an electronic jamming beacon, etc.), although the emitter may additionally or alternatively include any other type of emitter, source, beacon, and/or the like. For example, jamming emitters are typically used to disrupt and/or interfere with communication and navigation systems.

The system 100 may include one or more modules (e.g., the modules 110, 112, 114, 116, and 118, etc.) for performing various functions, operations, and/or the like of the system 100. In the illustrated implementation, the system 100 includes a signal receiver module 110, a processing module 112, a priority assessment module 114, an historical analysis module 116, and an output module 118. The architecture of the modules 110, 112, 114, 116, and 118 of the system 100 allows for comprehensive signal evaluation and/or emitter prioritization, ultimately enhancing operational effectiveness of the system 100 in environments with complex signal patterns.

In some examples, the system 100 performs a method that includes: receiving signals from potential emitters, wherein each signal has a measurable signal characteristic; identifying signal characteristics of the potential emitters; assigning priority levels to the potential emitters based on priority criteria of the potential emitters; and selecting one of the potential emitters using the assigned priority levels and the identified signal characteristics of the potential emitters.

In some examples, the system 100 performs a method that includes: receiving signals from multiple potential emitters, each signal having a measurable signal strength and associated characteristics; determining a baseline selection of a emitter based on the signal strength by identifying the strongest signal; augmenting the baseline selection by integrating a priority assessment, wherein the priority levels are assigned to each signal based on predefined criteria to allow differentiation among signals of comparable strength, thereby forming a prioritized emitter list; adjusting emitter selection dynamically, wherein an initial emitter identified based on signal strength is re-evaluated using historical signal data, enabling retention or switching of emitters that might exhibit intermittent, pulsing, and/or signal modifying behavior; and executing emitter prioritization commands based on the integrated assessment of signal strength and priority, for example to facilitate accurate emitter engagement in a dynamic environment.

The system 100 is designed, in some examples, to enhance emitter selection processes, for example for aircraft applications. The system 100 includes a configuration where the signal receiver module 110 acquires signals emitted by multiple potential emitters. Each of these signals have associated characteristics (e.g., measurable strength, etc.) which form initial emitter selection criteria. In some examples, and as is described herein, the processing module 112 works in conjunction with the signal receiver module 110 to determine an initial (e.g., the first, etc.) emitter by selecting the signal with the greatest measurable strength, thereby establishing a baseline for targeting.

In an aspect of the system 100, the priority assessment module 114 operates to assign priority levels to the detected signals. The priority assessment module 114 augments the initial emitter selection by evaluating criteria, thus allowing for the effective differentiation among signals that are comparable in strength. The differentiation among signals that are comparable in strength results in the formation of a prioritized emitter list, for enhancing operational efficacy in environments where numerous signals may be present and require further classification beyond mere strength comparison.

The signal receiver module 110 is configured to receive signals from multiple potential emitters, where the received signals possess a measurable strength and other associated characteristics. The receiving of signals by the signal receiver module 110 can be facilitated by various onboard sensors, receivers, and/or the like, for example designed to detect and assess the strength of incoming signals from the environment. In some examples, in addition or alternatively to the onboard sensors, receivers, and/or the like, the receiving of signals by the signal receiver module 110 can be facilitated by one or more sensors, receivers, and/or the like located offboard (e.g., remote from, etc.) the platform. “Measurable strength” refers to the quantifiable intensity of the signals received, which in some examples serves as a baseline criterion for initial emitter identification. “Associated characteristics” may include, but is not limited to, frequency, modulation patterns, persistence profiles, frequency characteristics, signal strength, directional orientation, positional coordinates, locations, metadata, metadata corresponding to an emission, metadata corresponding to an emitter (e.g., an emitter type, an emitter characteristic, an identification of friend or foe (IFF), etc.), metadata corresponding to an environmental condition, any other metadata, data detected and/or received at different times, and/or the like. As will be described below, in some examples the associated characteristics are used in prioritization processes.

The system 100 includes one or more sensors 120 that are configured to detect emissions from emitters. For example, one or more of the sensors 120 may include an RF sensor that is configured to detect RF emissions (e.g., signals, etc.) of emitters. For example, and although other ranges are within the scope of the present disclosure (e.g., any range of frequencies of the radio spectrum, any range from approximately 3 KHz to approximately 3,000 THz, etc.), one or more of the sensors 120 may be configured to scan a frequency range between approximately 1.2 GHz and approximately 5.8 GHz. The sensors 120 may include any number and/or different types of sensors, including, but not limited to, short-range radar, close-range radar, medium-range radar, long-range radar, frequency modulated continuous wave (FMCW) radar, and/or the like. In some examples, one or more of the sensors 120 includes a software defined radio (SDR).

Other examples of the sensors 120 include, but are not limited to, one or more non-RF sensors 120 that are configured to acquire non-RF data, for example for incorporation (e.g., integration) of non-RF information into the identification, detection, characterization, location, prioritization, and/or selection of an emitter (e.g., for emitter localization, informing emitter selection decisions, emitter engagement, etc.). Non-RF sensor(s) 120 may include any number and/or different types of non-RF sensors, such as, but not limited to, cameras, IR cameras, first person view (FPV) cameras, visual (visible spectrum) cameras, environmental monitors, LiDAR systems, and/or the like. Non-RF data acquired by the non-RF sensors 120 may include, but is not limited to, visual information, visual cues, IR information, heat signatures, environmental information, environmental variables, wind patterns, wind speeds, wind direction, terrain features, video footage, temperatures, and/or the like. The multi-sensor approach of aspects of the disclosure, for example, refines emitter localization and engagement, for example providing additional data (e.g., a heat signature, etc.) to validate emitter presence, optimize engagement strategies, aid in the approach and/or reaffirmation of emitter positions, and/or the like.

In some examples, following the reception of signals, the signal receiving module 110 and/or the processing module 112 proceeds to identify the signal strengths and/or other signal characteristics (e.g., a fingerprint, a signature, etc.) associated with the potential emitters. For example, this identification process of the signal strengths and/or other signal characteristics associated with the potential emitters may involve measuring the intensity, power level, and/or the like of each signal, thereby establishing a comparative basis for emitter evaluation. Identifying the signal strengths of potential emitters may include, in some examples, identifying the potential emitter having a highest identified signal strength among the potential emitters.

In some examples, signal strength serves as a (e.g., primary, etc.) criterion for initial emitter determination. For example, a baseline selection of an initial emitter is optionally made by the signal receiving module 110 and/or the processing module 112 by selecting the potential emitter having a highest identified signal strength the potential emitters. For example, the determination of the baseline selection may involve identification based on the signal with the strongest measurable strength. In some examples, the term “baseline selection” signifies the initial primary emitter selection step, using the strongest signal as the initial indicator of potential emitter priority. For example, “baseline selection” may refer to the initial process of prioritizing signals based strictly on strength criteria. Using signal strength as an initial marker ensures that the most detectable emitter receives preliminary consideration. In some examples, one or more other signal characteristics (e.g., a signature, a fingerprint, etc.) additionally or alternatively serves as a (e.g., primary, etc.) criterion for initial emitter determination (e.g., a baseline selection of an initial emitter, etc.)

The priority assessment module 114 assigns priority levels to the potential emitters based on priority criteria of the potential emitters (e.g., priority levels are assigned to each signal based on predefined criteria). For example, the priority assessment module 114 operates by evaluating signals received from potential emitters based on a set of predefined criteria that go beyond mere signal strength. In practical terms, the system 100 defines an approach to resolving instances where signal strength alone may not be a sufficiently reliable criterion for emitter selection, for example because multiple emitters nearby a desired emitter emit signals. For example, this occurs in environments where emitters are deliberately trying to mask their presence and/or where multiple emitters cluster in proximity, resulting in signal strengths and/or other signal characteristics that are difficult to separate using conventional measures. In some examples, the priority evaluation process refines the emitter selection process within the system 100.

In some examples, the system 100 is configured to augment the baseline selection of the initial emitter using the priority levels assigned to the potential emitter. Augmenting the baseline selection involves enhancing the initial emitter selection by integrating additional decision-making parameters, for example the priority criteria, etc. Through the process of augmentation, the baseline selection of the initial emitter may be replaced or retained as the eventual emitter selected. In other words, augmenting the baseline selection includes re-evaluating the baseline selection using the priority levels. The decision to modify the baseline selection depends on the assigned priority levels and how they affect the priority ranking of the potential emitters. In some examples, augmenting the baseline selection with the priority levels includes replacing the baseline selection of the initial emitter with selection of a different one of the potential emitters as the eventual emitter. In some examples, augmenting the baseline selection with the priority levels includes retaining the initial emitter as the eventual emitter. The “eventual emitter” refers to the final selection made after considering both signal characteristics (e.g., strength, a signature, a fingerprint, etc.) and priority, for example providing a well-rounded approach to emitter engagement.

Optionally, the priority assessment performed by the priority assessment module 114 occurs onboard the platform, for example allowing for real-time decision-making during flight and/or other operations. In some examples, the goal is to differentiate among emitters that may exhibit relatively close signal strength (and/or other signal characteristic) values but differ in strategic, tactical, or desired importance. For example, the priority assessment module 114 assigns the priority levels to the potential emitters to differentiate among two of the potential emitters that have signal strengths (and/or other signal characteristics) within a threshold of each other. Moreover, and for example, a priority assessment could assign a higher priority to a signal indicative of relevance, beyond simple strength measures. For example, if two signals are received with strengths of 85% and 86% respectively, without priority assessment, both may seem equally important. However, upon analysis of their modulation techniques, known behavioral patterns, and/or the like, one signal is assigned a higher priority (e.g., due to its historical association with a critical emitter, specific threat level, and/or the like).

In some examples, upon acquisition of the received signals by the signal receiver module 110, the priority assessment module 114 accesses a database and/or a set of algorithms that contain the priority criteria necessary for priority determination. The priority criteria include, but are not limited to: frequency characteristics, content, and/or the like; modulation characteristics, patterns, and/or the like; signal behavior patterns; emitter significance; historical significance, for example of the signal of a potential emitter; a potential threat level associated with a potential emitter, signal source, and/or the like; signal persistence data of one of the potential emitters; signals received by the platform directly from the potential emitters; historical data analysis; a recorded history of signals emitted by the potential emitters; a temporal pattern of signals emitted by the potential emitters (e.g., the timing of signal transmissions, etc.); a spatial pattern of signals emitted by the potential emitters (e.g., the location of emissions sources relative to each other and the platform, etc.); a signature of signal characteristics of one of the potential emitters; a fingerprint of signal characteristics of one of the potential emitters; sensor data; visual camera data; FPV camera data; thermal camera data; IR camera data; short-range (e.g., 60 hz, etc.) radar data; FMCW radar data; and/or the like.

In some implementations of the priority assessment module 114, the priority assessment module employs computational algorithms to assign numerical priority levels to the signals of the potential emitters, which may, in some examples, reflect the relative importance, priority, and/or the like of the emitter (e.g., a source, a potential emitter, etc.). Optionally, the priority assessment process involves the cross-referencing of real-time data from current signal observations with historical data logs which may be stored onboard the platform and/or on an external database. Such historical data, in some examples, assists in identifying patterns of behavior in signals, such as those indicative of intermittent, pulsing, and/or signal modifying characteristics. In some examples, “intermittent and/or pulsing behavior” refers to a signal's temporal emission pattern, wherein the signal is not continuous but occurs in bursts, pulses, and/or the like. Such intermittent and/or pulsing behavior might be employed by tactical emitters to evade detection, confuse tracking systems, and/or the like. The capability to select these types of signals allows the system 100 to adapt dynamically, effectively engaging with emitters that might otherwise be overlooked if solely relying on continuous signal detection.

Once priority levels are established, the priority assessment module 114 may dynamically interact with the processing module 112, for example to adjust the initial emitter selection list. In some examples, the priority assessment module 114 facilitates differentiation among signals that possess similar strengths yet vary in priority, leading to the formulation of a prioritized emitter list. The prioritized list is, in some examples, designed to ensure that strategically significant emitters are engaged with precedence, thus optimizing the operational efficacy of the system 100. The prioritized emitter list allows for differentiation among signals with relatively comparable strengths. In some examples, a “prioritized emitter list” refers to an ordered array of potential emitters ranked according to the assigned priority, for example to facilitate strategic decision-making when multiple signals of similar strength are present. The application of the priority criteria and the subsequent assignment of priority levels empower the system 100 to create a more nuanced and/or strategically informed list of emitters. For example, by forming a prioritized emitter list, operational decisions are not just reactive to signal strength but are proactive in engaging the most pertinent emitters.

The priority assessment module 114 enables a multi-dimensional analysis of the received signals, for example in environments with complex and potentially deceptive signal landscapes. The use of priority levels effectively allows the system 100 to bypass conventional limitations associated with a narrow focus on signal intensity, facilitating an informed selection of emitters, even amongst closely matched signals. This increases the likelihood of engaging truly high-value and/or high-threat emitters and/or refining engagement strategies.

After assigning the priority levels, the processing module 112 of the system 100 selects one of the potential emitters as the eventual emitter. This selection is accomplished by integrating both the assigned priority levels and the previously identified signal strengths and/or other signal characteristics, ensuring a comprehensive and contextually informed choice. In some examples, the eventual emitter selected exhibits intermittent, pulsing, and/or signal modifying behavior. In some examples, the eventual emitter selected has an identified signal strength that is less than a highest identified signal strength of the potential emitters. Optionally, the selection performed by the processing module 112 occurs onboard the platform, for example allowing for real-time decision-making during flight and/or other operations.

Once the eventual emitter has been selected, the output module 118 executes emitter prioritization commands for the selected emitter. In some examples, “emitter prioritization commands” encompass actions derived from the analysis, for example initiating engagement protocols based on the synthesized signal data and/or the like. For example, suitable actions may be requested, commanded, initiated, taken, performed, and/or the like by the system 100 when an emitter is selected as disclosed herein. Examples of actions of the system 100 with respect to the selected emitter may include, but are not limited to, maneuvering a platform to avoid the selected emitter; performing an engagement, enforcement, and/or threat mitigation action on the selected emitter (e.g., communicating with, hailing, engaging, damaging, neutralizing, destroying, limiting, wounding, restricting, mitigating, and/or the like the selected emitter, etc.); instructing an ordinance to detonate at a threshold distance and/or within a range of the selected emitter; overlaying sensor data on a radar image of the signal emitted by the selected emitter; generating and/or revising a prioritized emitter list that includes the selected emitter; generating and displaying a GUI representation that includes the selected emitter and data thereof (e.g., signal strength data, associated characteristics, other signal characteristics, priority criteria, etc.).

By factoring in both signal strength (and/or other signal characteristics) and priority, the system 100 augments the emitter selection process, enabling the platform to effectively prioritize and engage the most relevant emitters from a field of multiple options. This feature supports precise emitter engagement in dynamic contexts, ensuring that platform systems can accurately and efficiently respond to variably emitted signals. The architecture of the system 100, embodied in both hardware configurations and software-executable methods, showcases an adaptable and robust approach to emitter selection that can cater to complex signal landscapes.

Referring now to the historical analysis module 116, the historical analysis module 116 is configured to dynamically adjust emitter selection strategies by evaluating, processing, and/or the like historical signal data, for example enabling retention and/or switching of emitters that exhibit intermittent, pulsing, and/or signal modifying characteristics. In other words, the historical analysis module 116 integrates the priority assessment disclosed herein with historical signal data to enhance the emitter selection performed by the system 100. In some examples, the historical signal data is employed to refine (e.g., re-evaluate, etc.) the initial choice (e.g., the initial emitter, etc.) of a baseline selection. For example, utilizing past emission patterns, the historical analysis module 116 may evaluate historical consistency (e.g., intermittent, pulsing, and/or signal modifying behavior, etc.), for example enabling informed retention or replacement of an initially selected emitter.

The historical analysis module 116 enhances emitter selection by incorporating the ability to recognize and prioritize signals based on their temporal patterns (e.g., intermittent, pulsing, and/or signal modifying characteristics, etc.). In some examples, the historical analysis module 116 analyzes signal persistence data of the potential emitters, for example to determine the presence of one or more of the potential emitters within signal receiving range of the platform using the analyzed signal persistence data, inform selection of the eventual emitter, re-evaluate a baseline selection, and/or the like. Signal persistence data may include, but is not limited to: signal pulse data; intermittent signal data; signal modifying data; signals received by the platform directly from the potential emitters; signals received by the platform directly from the potential emitters within a past period of time; signals recently received by the platform directly from the potential emitters; a recorded history of signals emitted by the potential emitters; and/or the like.

Based on the analyzed signal persistence data (and/or the determined presence, the priority assessment, etc.), the processing module 112 selects one of the potential emitters as the eventual emitter. In some examples, the eventual emitter is selected for a threshold period of time.

In some examples, the system 100 (e.g., the historical analysis module 116, the priority assessment module 114, the processing module 112, and/or the like) incorporates a dynamic weighting algorithm that adjusts the priority levels determined by the priority assessment module 114 based on the historical consistency of signal strength (and/or other signal characteristic) fluctuations. The system 100 evaluates the persistence and changes in signal patterns over time to determine how transient the signal behavior is. Such an assessment enables the system 100 to prioritize emitters exhibiting stable signal patterns over those with erratic fluctuations, for example improving decision-making during emitter selection. In some examples, evaluating the persistence and changes in signal patterns over time includes analyzing a recorded history of signals emitted by one or more of the potential emitters. The system 100 (e.g., the historical analysis module 116, the priority assessment module 114, the processing module 112, and/or the like) may, in some examples, determine a confidence level that one or more potential emitters are present within signal receiving range of the platform. For example, the analyzed recorded history and/or the confidence level may be input into the priority assessment module 114 for affecting one or more of the priority levels, may be used by the system 100 (e.g., the processing module 112, the output module 118, etc.) for affecting selection of the eventual emitter, and/or the like.

By aligning the emitter selection with both real-time data and historical insights, the system 100 enhances the precision and efficacy of aerial targeting and engagements. The historical analysis module 116 facilitates the retention or consequential switching of emitters, particularly in scenarios where signals exhibit intermittent, pulsing, and/or signal modifying behaviors, which could otherwise mislead or confuse static selection systems. The adaptability of the system 100 is thereby notably enhanced, for example providing fluid responsiveness to changing signal environments, which may be particularly helpful in identifying emitters using deceptive tactics designed to obscure consistent detection.

In some implementations, the system 100 employs signal fingerprinting capabilities including signal feature discrimination techniques (e.g., using FFTs, spectral analysis, emitter prioritization algorithms, machine learning, etc.) to analyze frequency characteristics, for example to create distinct signal fingerprints, which allows for enhanced classification and/or more precise emitter selection. For example, the processing module 112 may analyze a fingerprint of signal characteristics of one or more of the potential emitters. The analyzed fingerprint may be input into the priority assessment module 114 for affecting one or more of the priority levels, may be used by the system 100 (e.g., the processing module 112, the output module 118, etc.) for affecting selection of the eventual emitter, and/or the like.

A “fingerprint” and/or “signature” of signal characteristics includes, but is not limited to, signal strength characteristics, signal pulse characteristics, signal modification characteristics, signal modulation characteristics, signal intermittent characteristics, signal amplification characteristics, signal frequency characteristics, signal frequency content characteristics, power density characteristics, power density function characteristics across a bandwidth of modulation, continuous wave (CW) signal characteristics, global positioning system (GPS) modulation characteristics, white noise characteristics, and/or the like.

The system 100 may operate, in some examples, by detecting and analyzing the unique fingerprints and/or signatures of the potential emitters using various methods, including, but not limited to: signal strength assessment and/or frequency analysis (e.g., through FFTs, spectral analysis, emitter prioritization algorithms, machine learning, etc.); employing priority criteria tailored to recognize the distinctive features of a type of signal (e.g., a jamming signal, etc.). By assigning high priority to these threats, the system 100 effectively integrates them into the prioritized emitter list and ensures timely and appropriate response measures.

In some examples, the system 100 enhances signal discrimination by analyzing a comprehensive dataset of known signal fingerprints and/or signatures (e.g., using emitter prioritization algorithms, machine learning models, etc.). The system 100 is trained, in some examples, to recognize novel patterns and classify signals based on correlation with existing fingerprint libraries. The ability to adaptively learn from new signal data facilitates real-time updates to emitter prioritization, for example in environments with evolving emitter technologies.

By employing signal feature discrimination techniques, the system 100 accomplishes discrimination of signals based on frequency and/or modulation patterns, for example creating distinct fingerprints and/or signatures for more precise signal classification.

The system 100 includes, in some examples, multi-sensor integration (e.g., the incorporation of multi-sensor inputs), for example for emitter localization, informing emitter selection decisions, and/or emitter engagement. The sensor data is collected by one or more sensors located onboard the platform. For example, aspects of the disclosure integrate IR camera data, thermal camera data, FPV camera data, visual (visible spectrum) camera data, short-range radar data, close-range radar data, medium-range radar data, long-range radar data, FMCW radar data, and/or the like. The processing module 112 analyzes the sensor data and the result is input into the priority assessment module 114 for affecting one or more of the priority levels, which is used by the system 100 (e.g., the processing module 112, the output module 118, etc.) to change selection of the eventual emitter. In some examples, sensor data is overlayed on a radar image (e.g., a signal map, etc.) of the signal emitted by one or more of the potential emitters.

In some examples, multi-sensor fusion is achieved by integrating outputs from the sensors into a single composite visualization interface (e.g., using the GUI 108, etc.). For example, the integrated display offers operators a synthesized view of potential emitters, for example with overlays indicating signal strength, heat signature intensity, radar-detected proximity, and/or the like. By cohesively presenting this information, the system 100 aids in quickly validating emitter relevance and reducing the time required for decision-making. The multi-sensor approach of the system 100 refines emitter localization and/or engagement, for example providing additional data (e.g., a heat signature, etc.) to validate emitter presence, optimize engagement strategies, aid in the approach and/or reaffirmation of emitter positions, and/or the like.

Close-range radar deployment for emitter engagement is provided by the system 100 in some examples. For example, the system 100 (e.g., the processing module 112, the output module 118, etc.) may instruct an ordinance (e.g., held by the platform, launched from the platform, launched by another platform, etc.) at the selected emitter to detonate at a threshold distance and/or within a range determined using a sensor (e.g., a short-range radar, a close-range radar, an FMCW radar, etc.) onboard the ordinance and/or the platform, which enhances accuracy in emitter engagement phases, for example by facilitating optimal detonation by providing precise targeting information and/or potentially obviating the need for impact detonation.

In some implementations, the system 100 is designed with modular software components that allow for configuration updates via secure wireless communication channels. The modular components enable operators to modify parameters (e.g., alter signal characteristic thresholds, reprioritize signal types, etc.) without physically accessing the system 100. Such configurability enhances operational flexibility of the system.

In some examples, the system 100 integrates a feedback loop mechanism within the priority assessment module 114, for example allowing for real-time recalibration of priority weighing factors (e.g., the priority criteria, etc.). Such a feedback loop utilizes current operational data to refine signal priority algorithms, ensuring the system 100 remains responsive to changing conditions.

In some implementations, the system 100 generates and displays a GUI representation (e.g., on the GUI 108, etc.) of the configurable options available pre-launch of the ordinance and/or pre-launch of the platform. In some examples, the GUI representation depicts how an operator can tailor settings (e.g., signal strength thresholds, priority criteria, etc.) to match objectives and/or threat environments.

In an exemplary scenario, the system 100 is employed using the platform's onboard systems to evaluate signals from potential emitters in a cluttered electromagnetic environment. By integrating a robust database of known signal behaviors, the system 100 discerns priority levels, for example enabling the platform to focus on high-value emitters and/or mitigating the risk of engaging decoys or less significant emitters.

Another exemplary scenario within which the system 100 may be used is a scenario wherein the potential emitters are electronic jamming emitters (e.g., electronic jamming beacons, etc.). In operational settings, the jamming emitters are typically used to disrupt or interfere with communication and navigation systems. The inclusion of electronic jamming emitters as potential emitters differentiates the capabilities of the system 100, for example enabling the system 100 to identify and/or prioritize emitters effectively.

An example of an operational scenario of the system 100 involves a platform tasked with maintaining secure communications in a relatively highly-contested electronic environment where jamming emitters are prevalent. The system 100 identifies these emitters as potential emitters by evaluating their emission patterns and/or modulation characteristics, which commonly differ from other signals due to their jam-focused nature. If the immediate goal is to neutralize these disruptive elements, the system 100 prioritizes engagements with jamming emitters.

In another scenario, the system 100 is used to support an electronic warfare (EW) operations team, where rapid identification and response to jamming threats are crucial. In some examples, the priority assessment module 114 dynamically adjusts the emitter selection process to account for new jamming attempts, for example leveraging historical data and/or recorded signal behaviors to anticipate and/or mitigate interference. By understanding both the operational intent and frequency usage of jamming emitters, the system 100 effectively counters electronic threats while supporting objectives. In some examples, aspects of the disclosure are operable in GPS-denied or GPS-spoofed environments.

Another example of the system 100 in operation is an airborne platform receiving signals from a cluster of ground-based emitters, where one emitter employs a pulsing and/or intermittent transmission strategy. Traditional systems might prioritize continuous signals, potentially dismissing the pulsing and/or intermittent emitter. However, the system 100 assigns priority levels that account for the strategic importance of irregular transmission patterns, for example ensuring that tactical advantages introduced by the pulsing and/or intermittent emitter are mitigated through prioritization and eventual selection of the pulsing and/or intermittent emitter.

An example of replacing a baseline selection of an initial emitter will now be described. This example involves a scenario where two emitters have similar signal strengths, but one emitter has a higher priority (e.g., due to its historical data indicating a strategic threat, etc.). In this case, although another emitter had the highest initial signal strength, the system 100 replaces the baseline selection of the initial emitter with selection of the higher-priority emitter (e.g., given the additional contextual information, etc.).

An example of retaining the baseline selection of the initial emitter will now be described. In this scenario, if the initial emitter of the baseline selection identified by signal strength additionally aligns with the highest priority criteria (e.g., emitting a distinct fingerprint associated with a critical emitter, etc.), the system 100 retain the baseline selection of the initial emitter as the selected eventual emitter (e.g., the baseline and priority evaluations converge on the same outcome, etc.).

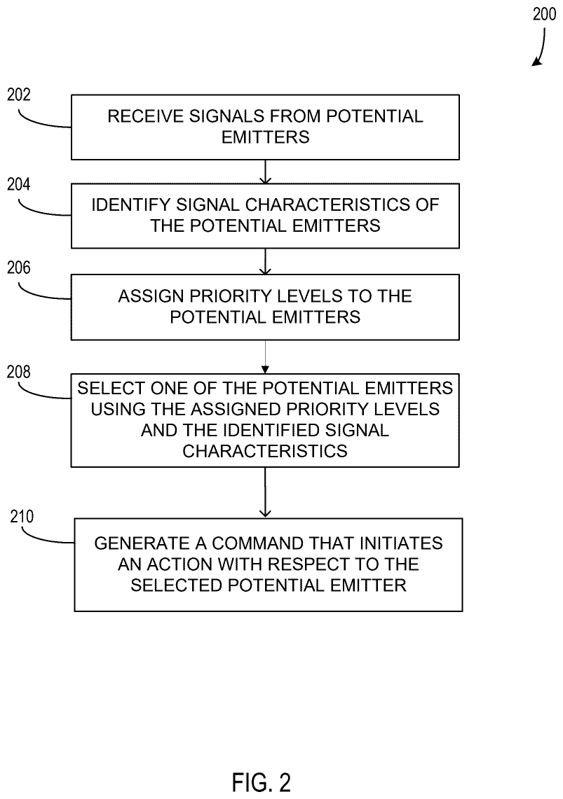

FIG. 2 is a flowchart illustrating an example of a method 200 of operations, functions, and/or the like of the system 100 (FIG. 1). At 202, the method includes receiving signals from potential emitters, wherein each signal has a measurable signal characteristic. The method 200 includes identifying, at 204, signal characteristics of the potential emitters. At 206, the method 200 includes assigning priority levels to the potential emitters based on priority criteria of the potential emitters. At 208, the method 200 includes selecting one of the potential emitters using the assigned priority levels and the identified signal characteristics of the potential emitters. At 210, the method 200 includes generating a command that initiates an action with respect to the selected potential emitter.

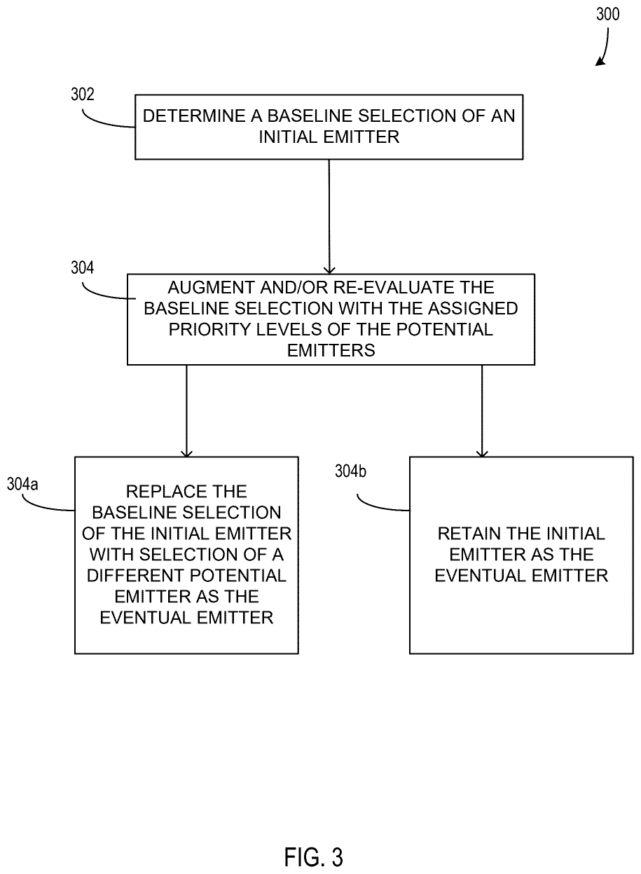

FIG. 3 is a flowchart illustrating an example of a method 300 of operations, functions, and/or the like of the system 100 (FIG. 1). At 302, selecting one of the potential emitters (e.g., at 208 of the method 200 shown in FIG. 2, etc.) includes determining a baseline selection of an initial emitter by selecting the potential emitter having a highest identified signal strength among the potential emitters. At 304, selecting one of the potential emitters (e.g., at 208 of the method 200 shown in FIG. 2, etc.) includes augmenting and/or re-evaluating the baseline selection with the assigned priority levels of the potential emitters to select an eventual emitter among the potential emitters.

In some examples, augmenting and/or re-evaluating at 304 the baseline selection with the assigned priority levels includes replacing, at 304a, the baseline selection of the initial emitter with selection of a different one of the potential emitters as the eventual emitter. In some examples, augmenting and/or re-evaluating at 304 the baseline selection with the assigned priority levels includes retaining, at 304b, the initial emitter as the eventual emitter.

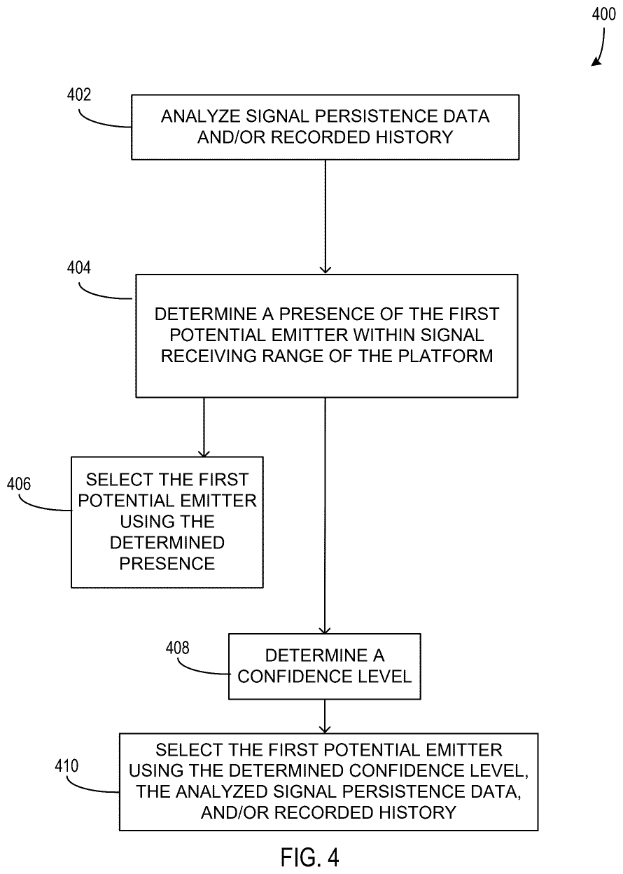

FIG. 4 is a flowchart illustrating an example of a method 400 of operations, functions, and/or the like of the system 100 (FIG. 1). At 402, assigning priority levels to the potential emitters (e.g., at 206 of the method 200 shown in FIG. 2, etc.) includes analyzing signal persistence data of a first of the potential emitters and/or analyzing a recorded history of signals emitted by the potential emitters. At 404, assigning priority levels to the potential emitters (e.g., at 206 of the method 200 shown in FIG. 2, etc.) includes determining a presence of the first potential emitter within signal receiving range of the platform using the analyzed signal persistence data and/or the analyzed recorded history.

Optionally, selecting one of the potential emitters (e.g., at 208 of the method 200 shown in FIG. 2, etc.) includes selecting, at 406, the first potential emitter using the determined presence of the first potential emitter within signal receiving range of the platform. In some examples, assigning priority levels to the potential emitters (e.g., at 206 of the method 200 shown in FIG. 2, etc.) includes determining, at 408, a confidence level that a first of the potential emitters is present within signal receiving range of the platform. At 410, selecting one of the potential emitters (e.g., at 208 of the method 200 shown in FIG. 2, etc.) optionally includes selecting the first potential emitter using the determined confidence level, the analyzed signal persistence data, and/or the analyzed recorded history.

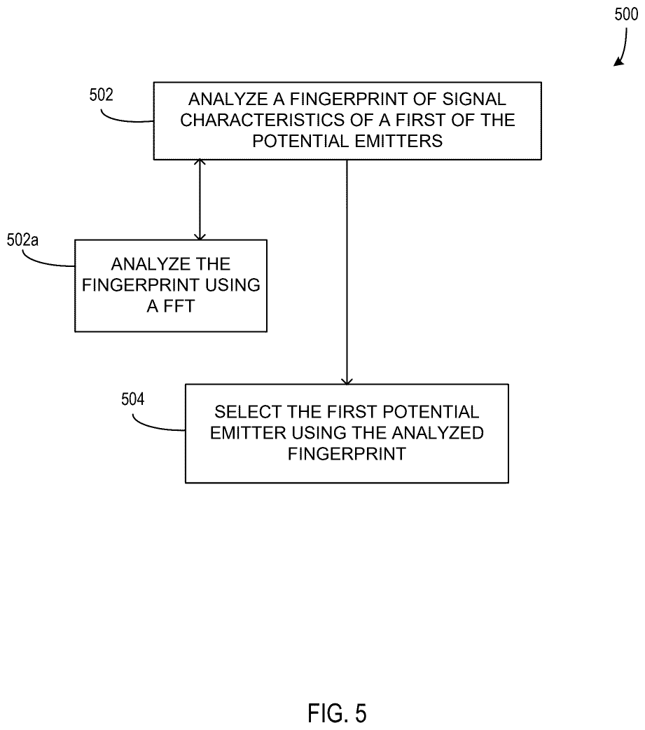

FIG. 5 is a flowchart illustrating an example of a method 500 of operations, functions, and/or the like of the system 100 (FIG. 1). At 502, assigning priority levels to the potential emitters (e.g., at 206 of the method 200 shown in FIG. 2, etc.) includes analyzing a fingerprint of signal characteristics of a first of the potential emitters. At 504, selecting one of the potential emitters (e.g., at 208 of the method 200 shown in FIG. 2, etc.) includes selecting the first potential emitter using the analyzed fingerprint. Optionally, analyzing the fingerprint of signal characteristics at 502 includes analyzing, at 502a, the fingerprint of signal characteristics using an FFT.

FIG. 6 illustrates an exemplary implementation of the system 100 being deployed onboard a mobile platform 600. The system 100 is configured to perform the operations disclosed herein (e.g., scanning, identifying, detecting, characterizing, locating, prioritizing, selecting, generating, etc.) from onboard the mobile platform 600, for example which enables operators to more effectively monitor and manage emitter activity and thereby improve the accuracy of detection, prioritization, and selection of emitters while the mobile platform 600 is in transit. For example, the system 100 may detect, prioritize, and select signals of interest from emitters 602 (e.g., stationary emitters, mobile emitters, etc.) as the mobile platform 600 moves along a path (e.g., a flight path, a ground path, a marine path, etc.). In some examples, the system 100 is configured to locate the source of the signals of interest that the system 100 determines to be relevant. For example, the system 100 may locate emitters 602 detected while the mobile platform 600 moves along the path that the system 100 has characterized as one or more of an unknown emitter, an emitter that is located in unauthorized airspace, an emitter that is not authorized to approach the location of the mobile platform 600, a threat (e.g., a physical threat, an interference threat, a jamming threat, etc.), and/or the like.

Suitable actions may be taken by the system 100 when an emitter 602 detected from the mobile platform 600 is selected as disclosed herein. For example, maneuvering the mobile platform 600 to avoid one or more emitters, enforcement actions, threat mitigation, and/or the like may be generated, requested, commanded, initiated, and/or the like by the system 100 when a detected emitter 602 is selected.

In another example of operation of the system 100 onboard the mobile platform 600, the system 100 performs signal landscape mapping (e.g., creating a new landscape map of signals emitted by the emitters 602, updating an existing landscape map of signals emitted by the emitters 602, etc.) as the mobile platform 600 moves along the path. Another example includes navigating the mobile platform 600 along a navigation path (e.g., a flight path, etc.) utilizing a landscape map and/or utilizing the relevance, characterizations, locations, prioritization, and/or selection of at least one of the emitters 602 detected while the mobile platform 600 moves along the path.

Although shown as a UAV rotorcraft, the mobile platform 600 is not limited thereto but rather may include any other type of mobile platform.

### Exemplary Operating Environment

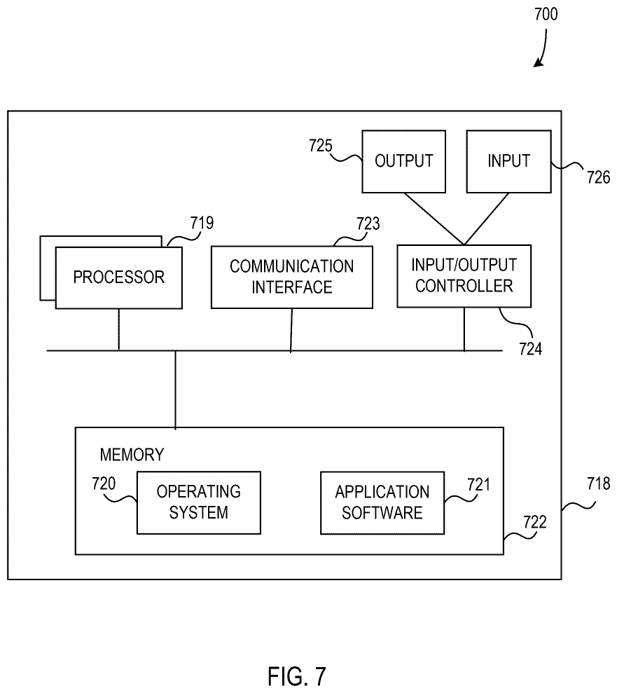

The present disclosure is operable with a computing apparatus according to an implementation as a functional block diagram 700 in FIG. 7. In an example, components of a computing apparatus 718 are implemented as a part of an electronic device according to one or more implementations described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hard-coded machine. In some examples, platform software comprising an operating system 720 or any other suitable platform software is provided on the apparatus 718 to enable application software 721 to be executed on the device.

In some examples, computer executable instructions are provided using any computer-readable media that is accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display (e.g., displaying a GUI, etc.) or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receives output from the output device(s) 725.

The functionality described herein can be performed, at least in part, by one or more hardware logic components. According to an implementation, the computing apparatus 718 is configured by the program code when executed by the processor 719 to execute the implementations of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Aspects of the disclosure include a computer-implemented method that includes: receiving, by a platform, signals from potential emitters, wherein each of the signals has a measurable signal characteristic; identifying signal characteristics associated with the potential emitters; assigning a priority level to each of the potential emitters based on one or more priority criteria of the potential emitters; and selecting one of the potential emitters using the assigned priority levels and the identified signal characteristics of the potential emitters.

In some examples, assigning the priority levels to the potential emitters based on the priority criteria comprises assigning the priority levels using priority criteria comprising at least one of: frequency characteristics, modulation characteristics, modulation patterns, signal behavior patterns, emitter significance, historical significance, a potential threat level associated with a signal, signal persistence data of one of the potential emitters, signals received by the platform directly from the potential emitters, historical data analysis, a recorded history of signals emitted by the potential emitters, a temporal pattern of signals emitted by the potential emitters, a spatial pattern of signals emitted by the potential emitters, a signature of signal characteristics of one of the potential emitters, a fingerprint of signal characteristics of one of the potential emitters; sensor data; visual camera data, first person view (FPV) camera data; thermal camera data, infrared (IR) camera data, short-range radar data, or frequency modulated continuous wave (FMCW) radar data.

In some examples, assigning the priority levels to the potential emitters includes differentiating among two or more of the potential emitters that have signal characteristics within a threshold of each other.

In some examples, selecting one of the potential emitters includes selecting an eventual emitter that exhibits at least one of intermittent, pulsing, or signal modifying behavior.

In some examples, selecting one of the potential emitters includes selecting one of the potential emitters that has an identified signal strength that is less than a highest identified signal strength of the potential emitters.

In some examples, identifying the signal characteristics of potential emitters includes identifying the potential emitter having a highest identified signal strength among the potential emitters.

In some examples, selecting one of the potential emitters includes: determining a baseline selection of an initial emitter by selecting the potential emitter having a highest identified signal strength among the potential emitters; and augmenting the baseline selection with the assigned priority levels of the potential emitters to select an eventual emitter among the potential emitters.

In some examples, augmenting the baseline selection with the assigned priority levels includes replacing the baseline selection of the initial emitter with selection of a different one of the potential emitters as the eventual emitter.

In some examples, augmenting the baseline selection with the assigned priority levels includes retaining the initial emitter as the eventual emitter.

In some examples, selecting one of the potential emitters includes: determining a baseline selection of an initial emitter by selecting the potential emitter having a highest identified signal strength among the potential emitters; and re-evaluating the baseline selection of the initial emitter using the assigned priority levels of the potential emitters.

In some examples, re-evaluating the baseline selection of the initial emitter includes changing the baseline selection of the initial emitter to selection of a different one of the potential emitters as an eventual emitter.

In some examples, re-evaluating the baseline selection of the initial emitter includes retaining the initial emitter as an eventual emitter.

In some examples, assigning the priority levels to the potential emitters includes generating a prioritized emitter list of the potential emitters.

In some examples, assigning the priority levels to the potential emitters includes: analyzing signal persistence data of a first of the potential emitters; and determining a presence of the first potential emitter within signal receiving range of the platform using the analyzed signal persistence data.

In some examples, selecting one of the potential emitters includes selecting the first potential emitter using the determined presence of the first potential emitter within signal receiving range of the platform.

In some examples, selecting one of the potential emitters includes selecting the first potential emitter for a threshold period of time using the determined presence of the first potential emitter within signal receiving range of the platform.

In some examples, signal persistence data includes at least one of: signal pulse data; intermittent signal data; signal modifying data; signals received by the platform directly from the potential emitters; signals received by the platform directly from the potential emitters within a past period of time; signals recently received by the platform directly from the potential emitters; or a recorded history of signals emitted by the potential emitters.

In some examples, assigning the priority levels to the potential emitters includes: analyzing a recorded history of signals emitted by the potential emitters; and determining that a first of the potential emitters is present within signal receiving range of the platform using the analyzed recorded history.

In some examples, selecting one of the potential emitters includes at least one of: selecting the first potential emitter using the determined presence of the first potential emitter within signal receiving range of the platform; or selecting the first potential emitter for a threshold period of time using the determined presence of the first potential emitter within signal receiving range of the platform.

In some examples, assigning the priority levels to the potential emitters includes: analyzing a recorded history of signals emitted by the potential emitters; and determining a confidence level that a first of the potential emitters is present within signal receiving range of the platform; wherein selecting one of the potential emitters includes selecting the first potential emitter using the analyzed recorded history and the determined confidence level.

In some examples, assigning the priority levels to the potential emitters includes analyzing at least one of a spatial or a temporal pattern of signals emitted by the potential emitters; and selecting one of the potential emitters includes selecting one of the potential emitters using the analyzed at least one of spatial or temporal pattern.

In some examples, assigning the priority levels to the potential emitters includes analyzing a fingerprint of signal characteristics of a first of the potential emitters; and selecting one of the potential emitters includes selecting the first potential emitter using the analyzed fingerprint.

In some examples, the fingerprint of signal characteristics includes at least one of signal strength characteristics, signal pulse characteristics, signal modification characteristics, signal intermittent characteristics, signal modulation characteristics, signal amplification characteristics, signal frequency characteristics, signal frequency content characteristics, power density characteristics, power density function characteristics across a bandwidth of modulation, continuous wave (CW) signal characteristics, global positioning system (GPS) modulation characteristics, or white noise characteristics.

In some examples, analyzing the fingerprint of signal characteristics includes analyzing the fingerprint of signal characteristics using a Fast Fourier Transform (FFT).

In some examples, assigning the priority levels to the potential emitters includes analyzing sensor data of at least one of the potential emitters; and selecting one of the potential emitters includes selecting one of the potential emitters using the analyzed sensor data.

In some examples, the sensor data includes at least one of visual camera data, first person view (FPV) camera data, thermal camera data, infrared (IR) camera data, short-range radar data, or frequency modulated continuous wave (FMCW) radar data.

In some examples, analyzing the sensor data includes overlaying the sensor data on a radar image of the signal emitted by the potential emitters.

In some examples, the analyzed sensor data is collected by a sensor located onboard the platform.

In some examples, the method further includes instructing an ordinance launched from the platform at the selected emitter to detonate at least one of at a threshold distance or within a range determined using a sensor onboard at least one of the ordinance or the platform, wherein the sensor comprises at least one of a short-range radar or a frequency modulated continuous wave (FMCW) radar.

In some examples, the potential emitters include an electronic jamming emitter.

In some examples, at least one of identifying signal characteristics associated with the potential emitters, assigning a priority level to each of the potential emitters based on one or more priority criteria of the potential emitters, or selecting one of the potential emitters using the assigned priority levels and the identified signal characteristics of the potential emitters is performed onboard the platform.

In some examples, the measurable signal characteristic incudes at least one of signal strength, a signature, or a fingerprint.

Aspects of the disclosure include a system that includes at least one processor; and a memory comprising computer program code, the memory and the computer program code configured to, with the at least one processor, cause the at least one processor to: receive, by a platform, signals from potential emitters, wherein each of the signals has a measurable signal characteristic; identify signal characteristics associated with the potential emitters; assign a priority level to each of the potential emitters based on one or more priority criteria of the potential emitters; and select one of the potential emitters using the assigned priority levels and the identified signal characteristics of the potential emitters.

Aspects of the disclosure include a computer-readable memory device storing instructions that, when executed by at least one processor, cause the at least one processor to: receive, by a platform, signals from potential emitters, wherein each of the signals has a measurable signal characteristic; identify signal characteristics associated with the potential emitters; assign a priority levels to each of the potential emitters based on one or more priority criteria of the potential emitters; and select one of the potential emitters using the assigned priority levels and the identified signal characteristics of the potential emitters.

Aspects of the disclosure include a method for enhancing emitter selection on a platform, executable via software, wherein the method includes receiving signals from multiple potential emitters, each of the signals having a measurable signal strength and associated characteristics; determining a baseline selection of an emitter based on a signal strength by identifying the signal having the strongest signal strength; augmenting the baseline selection by integrating priority levels, wherein one of the priority levels is assigned to each of the signals based on one or more criteria, thereby allowing differentiation among the signals of comparable strength and forming a prioritized emitter list; adjusting emitter selection dynamically, wherein an initial emitter identified based on signal strength is re-evaluated using historical signal data, enabling retention or switching of emitters that might exhibit intermittent, pulsing, and/or signal modifying behavior; and executing emitter prioritization commands based on an integrated assessment of signal characteristics and the priority levels to change the baseline selection of the emitter to another emitter.

Aspects of the disclosure include a system configured for enhancing emitter selection on a platform, wherein the system includes a signal receiver configured to acquire signals from a plurality of potential emitters, each of the signals characterized by measurable signal characteristics; at least one processor operatively coupled to the signal receiver, wherein the at least one processor is configured to determine an initial emitter selection by identifying a signal with the greatest of the measurable signal strengths; a priority assessor configured to assign a priority level to each of the signals based on one or more criteria, the priority assessor differentiating among the signals possessing similar signal characteristics, thereby resulting in a prioritized emitter list; a historical analyzer configured to dynamically adjust emitter selection by evaluating historical signal data, thereby retaining or adjusting the emitter selection; and an outputter configured to execute emitter prioritization commands based on the integrated assessment of the signal characteristics and the priority levels.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps, etc.) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
at least one processor; and
a memory comprising computer program code, the memory and the computer program code configured to, with the at least one processor, cause the at least one processor to:
receive, by a platform, signals from potential emitters, wherein each of the signals has a measurable signal characteristic;
identify signal characteristics associated with the potential emitters;
assign a priority level to each of the potential emitters based on one or more priority criteria of the potential emitters;
select one of the potential emitters using the assigned priority levels and the identified signal characteristics of the potential emitters; and
generate a command that initiates an action with respect to the selected potential emitter.

2. The system of claim 1, wherein the action initiated by the command comprises at least one of maneuvering the platform to avoid the selected potential emitter, engaging the selected potential emitter, performing an enforcement action against the selected potential emitter, performing a threat mitigation action against the selected potential emitter, instructing an ordinance to detonate at least one of at a threshold distance or within a range of the selected potential emitter, overlaying sensor data on a radar image of the signal emitted by the selected potential emitter, at least one of generating or revising a prioritized emitter list that includes the selected potential emitter, displaying a graphical user interface (GUI) representation that includes the selected potential emitter and data of the selected potential emitter.

3. The system of claim 1, wherein assigning the priority levels to the potential emitters based on the priority criteria comprises assigning the priority levels using priority criteria comprising at least one of: frequency characteristics, modulation characteristics, modulation patterns, signal behavior patterns, emitter significance, historical significance, a potential threat level associated with a signal, signal persistence data of one of the potential emitters, signals received by the platform directly from the potential emitters, historical data analysis, a recorded history of signals emitted by the potential emitters, a temporal pattern of signals emitted by the potential emitters, a spatial pattern of signals emitted by the potential emitters, a signature of signal characteristics of one of the potential emitters, a fingerprint of signal characteristics of one of the potential emitters, sensor data, visual camera data, first person view (FPV) camera data; thermal camera data, infrared (IR) camera data, short-range radar data, or frequency modulated continuous wave (FMCW) radar data.

4. The system of claim 1, wherein assigning the priority levels to the potential emitters comprises differentiating among two or more of the potential emitters that have signal characteristics within a threshold of each other.

5. The system of claim 1, wherein selecting one of the potential emitters comprises at least one of:
selecting an eventual emitter that exhibits at least one of intermittent, pulsing, or signal modifying behavior; or
selecting one of the potential emitters that has an identified signal strength that is less than a highest identified signal strength of the potential emitters.

6. The system of claim 1, wherein identifying the signal characteristics of potential emitters comprises identifying the potential emitter having a highest identified signal strength among the potential emitters.

7. The system of claim 1, wherein selecting one of the potential emitters comprises:
determining a baseline selection of an initial emitter by selecting the potential emitter having a highest identified signal strength among the potential emitters; and
augmenting the baseline selection with the assigned priority levels of the potential emitters to select an eventual emitter among the potential emitters.

8. The system of claim 1, wherein selecting one of the potential emitters comprises at least one of:
replacing a baseline selection of an initial emitter of the potential emitters with selection of a different one of the potential emitters as an eventual emitter;
changing the baseline selection of the initial emitter to selection of a different one of the potential emitters as the eventual emitter;
re-evaluating the baseline selection of the initial emitter using the assigned priority levels of the potential emitters;
retaining the initial emitter as the eventual emitter;
selecting a first potential emitter using a determined presence of the first potential emitter within signal receiving range of the platform; or
selecting the first potential emitter for a threshold period of time using the determined presence of the first potential emitter within signal receiving range of the platform.

9. The system of claim 1, wherein assigning the priority levels to the potential emitters comprises at least one of:
generating a prioritized emitter list of the potential emitters; or
analyzing signal persistence data of a first of the potential emitters and determining a presence of the first potential emitter within signal receiving range of the platform using the analyzed signal persistence data.

10. The system of claim 1, wherein assigning the priority levels to the potential emitters comprises:
analyzing a recorded history of signals emitted by the potential emitters; and
determining that a first of the potential emitters is present within signal receiving range of the platform using the analyzed recorded history.

11. The system of claim 1, wherein assigning the priority levels to the potential emitters comprises:
analyzing a recorded history of signals emitted by the potential emitters;
determining a confidence level that a first of the potential emitters is present within signal receiving range of the platform; and
wherein selecting one of the potential emitters comprises selecting the first potential emitter using the analyzed recorded history and the determined confidence level.

12. The system of claim 1, wherein:
assigning the priority levels to the potential emitters comprises analyzing at least one of a spatial or a temporal pattern of signals emitted by the potential emitters; and
selecting one of the potential emitters comprises selecting one of the potential emitters using the analyzed at least one of spatial or temporal pattern.

13. The system of claim 1, wherein:
assigning the priority levels to the potential emitters comprises analyzing a fingerprint of signal characteristics of a first of the potential emitters; and
selecting one of the potential emitters comprises selecting the first potential emitter using the analyzed fingerprint.

14. The system of claim 1, wherein assigning the priority levels to the potential emitters comprises analyzing a fingerprint of signal characteristics of a first of the potential emitters using a Fast Fourier Transform (FFT).

15. The system of claim 1, wherein:
assigning the priority levels to the potential emitters comprises analyzing sensor data of at least one of the potential emitters; and
selecting one of the potential emitters comprises selecting one of the potential emitters using the analyzed sensor data, wherein the sensor data comprises at least one of visual camera data, first person view (FPV) camera data, thermal camera data, infrared (IR) camera data, short-range radar data, or frequency modulated continuous wave (FMCW) radar data.

16. The system of claim 1, wherein at least one of identifying signal characteristics associated with the potential emitters, assigning a priority level to each of the potential emitters based on one or more priority criteria of the potential emitters, or selecting one of the potential emitters using the assigned priority levels and the identified signal characteristics of the potential emitters is performed onboard the platform.

17. A computer-implemented method comprising:
receiving, by a platform, signals from potential emitters, wherein each of the signals has a measurable signal characteristic;
identifying signal characteristics associated with the potential emitters;
assigning a priority level to each of the potential emitters based on one or more priority criteria of the potential emitters;
selecting one of the potential emitters using the assigned priority levels and the identified signal characteristics of the potential emitters; and
generating a command that initiates an action with respect to the selected potential emitter.

18. The method of claim 17, wherein the action initiated by the command comprises at least one of maneuvering the platform to avoid the selected potential emitter, engaging the selected potential emitter, performing an enforcement action against the selected potential emitter, performing a threat mitigation action against the selected potential emitter, instructing an ordinance to detonate at least one of at a threshold distance or within a range of the selected potential emitter, overlaying sensor data on a radar image of the signal emitted by the selected potential emitter, at least one of generating or revising a prioritized emitter list that includes the selected potential emitter, displaying a graphical user interface (GUI) representation that includes the selected potential emitter and data of the selected potential emitter.

19. A computer-readable memory device storing instructions that, when executed by at least one processor, cause the at least one processor to:
receive, by a platform, signals from potential emitters, wherein each of the signals has a measurable signal characteristic;
identify signal characteristics associated with the potential emitters;
assign a priority levels to each of the potential emitters based on one or more priority criteria of the potential emitters;
select one of the potential emitters using the assigned priority levels and the identified signal characteristics of the potential emitters; and
generate a command that initiates an action with respect to the selected potential emitter.

20. The computer-readable memory device of claim 19, wherein the action initiated by the command comprises at least one of maneuvering the platform to avoid the selected potential emitter, engaging the selected potential emitter, performing an enforcement action against the selected potential emitter, performing a threat mitigation action against the selected potential emitter, instructing an ordinance to detonate at least one of at a threshold distance or within a range of the selected potential emitter, overlaying sensor data on a radar image of the signal emitted by the selected potential emitter, at least one of generating or revising a prioritized emitter list that includes the selected potential emitter, displaying a graphical user interface (GUI) representation that includes the selected potential emitter and data of the selected potential emitter.
